(19) United States
(12) Patent Application Publication
(10) Pub. No.: US 2008/0169658 A1
(43) Pub. Date: Jul. 17, 2008

(54) FER AND IMPACT-RESISTANT PLATFORM LOCKING SYSTEM

(76) Inventor: Glen Wolf, Owatonna, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 12/014,411

(22) Filed: Jan. 15, 2008

Related U.S. Application Data
(60) Provisional application No. 60/884,965, filed on Jan. 15, 2007.
(60) Provisional application No. 60/884,963, filed on Jan. 15, 2007.

(51) Int. Cl. E05C 3/04

(52) U.S. Cl. 292/241

(57) ABSTRACT

A locking system for locking together the sashes of a window includes a base assembly, a cover assembly, and a keeper. The base assembly includes a cam receiver with an interchangeable cam that can engage the keeper so as to lock the window. The cover assembly includes an interchangeable shroud adapted to fit over the base assembly and a handle for rotating the cam. The base assembly, the cover assembly, and the keeper include additional features that resist forced entry through the window.

### RELATED APPLICATIONS

The present application claims the benefit of U.S. Provisional Application No. 60/884,963, entitled PLATFORM LOCK SYSTEM, filed Jan. 15, 2007, and U.S. Provisional Application 60/884,965, entitled FER AND IMPACT RESISTANT LOCK ASSEMBLY, filed Jan. 15, 2007, both of which are hereby fully incorporated herein by reference in their entireties.

### FIELD OF THE INVENTION

The present invention relates generally to window locks for double-hung, single-hung, and sliding windows.

### BACKGROUND OF THE INVENTION

Double-hung, single-hung, and sliding windows are commonly known in the art. A double hung window has an upper sash window and a lower sash window within a master frame. Typical sash locks are used to draw the sash windows together and lock them in place within the master frame. Likewise, in single hung and sliding windows the sash lock is used to draw the movable sash to the master frame and hold it in place.

In general, a sash lock includes a lock securable to one window sash of a window. The lock includes a base securable to the window sash, and a cam pivotable about a first axis relative to the base between an open and a locked position. The cam, when in the locked position, includes a portion that extends from the base to cooperatively engage a keeper element fixed to an opposing window sash. Rotation of the cam is accomplished through a handle. The handle is disposed to allow an operator to shift the cam position. The base is typically mounted to the rail by fastening means such as screws.

Typical locking devices are constructed from components made of metal, such as zinc or steel, to provide strength and forced-entry resistance (FER). Metal construction, however, has several drawbacks. For example, metal is relatively heavy, resulting in increased shipping costs. Metal is also subject to corrosion, especially in coastal applications. Therefore, there is a need for a platform locking system that incorporates a greater proportion of non-metal components while maintaining the structural integrity of the locking system and not jeopardizing the safety of the user.

Many sash locking systems are specifically adapted to particular window structural and special aesthetic requirements. These requirements vary between window manufacturers and even between window models. As a consequence, the components of sash lock assemblies are typically not interchangeable between models, leading to duplication of parts, inventory, varying assembly methods, and manufacturing inefficiencies. Therefore, there is a need for a standard lock platform that is quickly and easily adaptable to a multiplicity of different desired structural and aesthetic configurations. More specifically, there is a need for an inexpensive lightweight lock cover that cooperatively interacts with a variety of locking mechanisms.

Current standard locks typically include a lever handle, lock housing, and a cam with a wave washer. Current forced-entry resistant (FER) locks typically include the aforementioned components in addition to a movable barrier plate located under the cam, a strong detent spring to help prevent rotation of the lever handle, and/or a locking push-button in the center pivot of the lever handle to help prevent rotation of the lever handle. Standard locks and keepers for FER locks are typically constructed from a body with a single projecting tab on the upper portion of the keeper that engages an upper ribbed portion of the cam to provide a locking action between the upper and lower or right and left sashes of hung and sliding windows. A drawback of these systems, however, is that they fail to consistently satisfy current safety tests. For example, many sash locks are susceptible to manipulation from outside the window assembly by an intruder or damage or failure due to impact loads caused by strong winds. Therefore, there is also a need for a platform lock system that deters forced-entry gained through circumvention of the locking mechanism and more effectively resists damage due to impact loads.

Testing for impact resistance typically consists of shooting a projectile at the window assembly at various points to determine the resistance to passage of the projectile into interior spaces. Failure of window hardware during impact testing typically involves the cam disengaging from the keeper. A drawback of current keeper and lock designs is an inability to adequately resist disengagement of the cam due to impact forces.

Testing for forced-entry resistance (per ASTM F588) typically consists of applying increasing opposing loads to the upper and the lower sashes of the window in both horizontal and vertical directions and manipulating the window hardware for a specified period of time with simple hand tools such as a spatula or a piece of stiff steel wire. Grading, which runs from 10 to 40, corresponds increasing applied loads and manipulation times, with a minimum grade of 10 normally expected. Failure of window hardware during FER testing test typically occurs when manipulation causes the cam or the lever handle to be accessed to be accessed and rotated to an unlocked position. Therefore, there is a need for a platform lock system that eliminates the common failure modes discovered during impact and FER testing.

In addition, vinyl hung or sliding windows are often constructed without an interlocking feature between the upper and lower or right and left sashes. Therefore, there is also a need for a platform lock system that can add FER and impact protection to window systems without requiring routing for placement of the lock and/or keeper placement.

### SUMMARY OF THE INVENTION

Embodiments of the present invention address the aforementioned needs in the industry for a forced-entry and impact resistant locking system having freely interchangeable components. The locking system includes a base assembly, a cover assembly, and a keeper. The base assembly includes a housing and a cam. The cover assembly includes a shroud and handle. The keeper is generally adapted to receive the cam so as to lock a window in a closed position.

The base assembly can be mounted to a window lock rail by, for example, fastening through the housing and into a window sash. The keeper can be attached in a similar manner to another surface, such as, for example, a second window sash. The cover assembly, which may provide decorative features, can then be snap-fit onto the base assembly to complete the mounting of the locking system.

Embodiments of the present invention may provide a number of advantages over the prior art. In some embodiments, costs may be reduced through the elimination of zinc (which normally required for structural loading purposes) by using a stamped metal base frame to mount the rotatable cam. There may also be a cost savings through reducing labor to assemble the cam by using a “snap-fit” cam instead of having to spin the lever handle to the cam or use some other mechanical means to join the handle to the cam as is currently done on most locks today. In addition, lower costs can be achieved through eliminating the zinc required for the housing by using lower cost injection molded plastic housings instead. Further cost savings can be realized with plated finishes of the plastic decorative top cover by eliminating the polishing and special handling required for plated zinc parts.

Embodiments of the present invention may provide a greater range of options than the prior art that incorporates an integral housing and locking cam. The ability to interchange both the top cover assembly and the cam to fit a wide range of applications enables customization of functional and aesthetic characteristics. The ability to adapt the same base assembly to either top-mount or flush-mount applications with an appropriate top cover to fit is a further advantage. The removable top cover provides the user with the ability to hide mounting screws to add to aesthetic appeal. As windows are installed or finished, the exposed decorative covers for the locking mechanisms are frequently damaged or scratched. The ability to add or remove the top cover assembly provides an enhanced level of protection while accessing the windows. The installer thus can use the base assembly during construction/finishing and add the decorative cover afterwards or remove the cover for subsequent re-finishing to avoid damage or scratching of the decorative top cover assembly.

Embodiments of the present invention may include a number of removable or snap-fit parts, including the cam and the locking cover. These features may enable the base frame to be formed from injection molded plastic or stainless steel and the cam from a glass-filled nylon or other composite material to help meet stringent corrosion resistant requirements for coastal applications. A further advantage involves the ability to incorporate a detent feature into the base frame or cover housing for the locked and/or unlocked positions. This interchangable component system results in a more standardized locking system. Potential standardization of components (i.e. base frame, cams, handles) result in further cost savings through high volume purchasing.

Embodiments of the present invention may also provide additional forced-entry resistance. These embodiments may include overlapping stationary barrier plates incorporated into the keeper and lock to provide FER lock manipulation protection by blocking both the cam and reducing access to the lever handle. In addition, the barrier plate on the keeper may provide a surface to fix a lower tab to engage the lower rib of the cam to improve impact resistance. This keeper may be made with typical zinc die cast materials or as a sheet steel stamping with zinc plating. The keeper could alternatively be made as a sheet stainless steel stamping to provide coastal corrosion protection. In other embodiments, the locking system can also use the current typical design of lock construction but with the addition of an overlapping barrier feature in the base assembly that engages a corresponding barrier feature incorporated into the keeper. Tabs and flanges incorporated into the keeper provide additional FER protection from manipulation of the lever handle by blocking access to the handle from outside the window.

Embodiments of the present invention reduce the need for “add-on” forced entry resistance devices such as the separate “add-on” plate disclosed in U.S. Pat. No. 6,925,758, a movable barrier plate under the cam, a strong detent spring to help prevent rotation of the lever handle, and/or a locking push-button in the lever handle's center pivot to help prevent rotation of the lever handle by incorporating a barrier to access of the cam and/or lock lever handle within the keeper and lock base.

Embodiments of the present invention may provide additional forced-entry resistance by having an overlapping barrier feature incorporated into the keeper and lock bodies to prevent access to the cam and reduce access to the lever handle. Additional forced-entry resistance is provided by having a shroud over the keeper to block access to the lock lever handle. The window assembly is also provided with additional impact resistance through the use of both an upper and lower keeper tab to engage the both top and bottom surfaces of the cam and prevent disengagement upon impact.

Accordingly, in some embodiments, a window system according to the invention includes a window frame, a first window sash and a second window sash, at least one of the first window shaft and the second window shaft selectively shiftable within the window frame, and a locking system. The locking system comprises a base assembly on the first window sash including a housing and a first cam, the housing having an upper plate and a lower plate. The upper and lower plates define substantially parallel spaced-apart planes. The upper and lower plates also have cooperating structure for rotatably receiving and retaining the cam and are resiliently coupled so as to be deformably shiftable relative to each other to enable selective removal and replacement of the cam. The locking system also comprises a cover assembly over the base assembly including a shroud and a handle, the handle being operably connected to the first cam. The locking system further comprises a keeper on the second window sash that is adapted to receive the first cam.

In further embodiments the first cam may be selectively interchangeable with a second cam. The first cam may define a first flange configuration and present a first diameter and the second cam may define a second flange configuration and present a second diameter, the first and second flange configurations and the first and second diameters being different. The first cam may include upper and lower projections, the upper plate may define an upper cam-receiving aperture adapted to receive the upper projection of the cam, and the lower plate may define a lower cam-receiving aperture adapted to receive the lower cam projection. The cam may be rotatable within the upper and lower cam-receiving apertures. The housing may be adapted to retain the cam without a fastening member.

In other embodiments a window system according to the present invention includes a window frame, a first window sash and a second window sash, at least one of the first and second window sashes being selectively shiftable within the window frame, and a locking system. The locking system comprises a base assembly coupled to the first window sash. The base assembly may include a cam receiver and a cam selectively rotatable within the cam receiver, the cam receiver being resiliently deformable to receive the cam. The locking system also comprises a cover assembly over the base assembly, the cover assembly including a shroud and a handle, the handle being operably coupled to the first cam. The locking system further comprises a keeper on the second window sash that is adapted to receive the first cam.

In a further embodiment, a window system includes a window frame, a first window sash and a second window sash, at least one of the first and second window sashes being selectively shiftable within the window frame, and a locking system. The locking system comprises a base assembly on the first window sash, the base assembly including a cam receiver and a cam rotatably received in the cam receiver, the cam presenting an axis of rotation, the cam receiver defining a cam exit opening transverse to the axis of rotation of the cam, wherein the cam is selectively rotatable between a first position wherein a portion of the cam projects through the cam exit opening and a second position wherein the cam is clear of the cam exit opening, the base assembly further including a first barrier structure projecting outward from at least one side of the cam exit opening. The locking system further comprises a keeper on the second window sash, the keeper defining a cam-entry opening for receiving the cam and including a second barrier structure projecting outwardly relative to the cam-entry opening, the keeper further including first and second projections, the first projection being vertically registered with the second projection, wherein when the first and second sashes are positioned such that the cam exit opening of the base structure is registered with the cam entry opening of the keeper and the cam is positioned in the first position, the cam is engaged with the first and second projections and the first barrier structure and the second barrier structure are cooperatingly positioned to inhibit access to the cam from outside the window. In some embodiments, the first barrier structure and the second barrier structure overlap when the window is in a closed position. In some embodiments, the first projection substantially confronts and is slightly offset from the second projection. The cam may further define a flange comprising a pair of opposing generally vertical walls. When the first and second sashes are positioned such that the cam exit opening of the base structure is registered with the cam entry opening of the keeper and the cam is positioned in the first position, a portion of one of the vertical walls is positioned behind the first projection and a portion of the other of the vertical walls is positioned behind the second projection. The first and second projections may be substantially parallel to the axis of rotation of the cam.

Further embodiments of the invention may include a method of reconfiguring a window system, the window system including a first window sash, a second window sash selectively shiftable in relation to the first window sash, and a locking system, the locking system including a first cover assembly operably attached to a base assembly, the base assembly having a cam receiver and a first cam rotatable within the cam receiver. The method includes detaching the cover assembly from the base assembly and removing the cam from the base assembly. In further embodiments, the step of removing the cam from the base assembly further includes detaching a first handle unit from a first shroud. In embodiments of the invention, the method may further include the step of attaching a second cover assembly, which may itself include a step of attaching a second handle unit to a second shroud.

### BRIEF DESCRIPTION OF THE DRAWINGS

The embodiments of the present invention may be more completely understood in consideration of the following detailed description of various embodiments in connection with the accompanying drawings, in which:

FIG. 1 is a perspective view of a locking system according to an embodiment of the present invention mounted to a double-hung window depicted in a partially open position;

FIG. 2 is an exploded perspective view of a locking system according to an embodiment of the present invention;

FIG. 3 is a perspective view of a cover assembly according to an embodiment of the present invention;

FIG. 4 is a perspective view of a cover assembly according to an embodiment of the present invention;

FIG. 5 is a bottom plan view of a cover assembly according to an embodiment of the present invention;

FIG. 6 is a sectional side elevation view of a cover assembly according to an embodiment of the present invention;

FIG. 7 is a sectional side elevation view of a cover assembly according to an embodiment of the present invention;

FIG. 8 is a side perspective view of a cover assembly according to an embodiment of the present invention;

FIG. 9 is a perspective view of a shroud of a cover assembly according to an embodiment of the present invention;

FIG. 10 is a perspective view of a handle of a cover assembly according to an embodiment of the present invention;

FIG. 11 is a side elevation view of a handle of a cover assembly according to an embodiment of the present invention;

FIG. 12 is a bottom plan view of a handle of a cover assembly according to an embodiment of the present invention;

FIG. 13 is a perspective view of a base assembly attached to a window sash according to an embodiment of the present;

FIG. 14 is a perspective view of a base assembly according to an embodiment of the present invention;

FIG. 15 is a perspective view of a housing of a base assembly according to an embodiment of the present invention;

FIG. 16 is top plan view of a housing of a base assembly according to an embodiment of the present invention;

FIG. 17 is a front elevation view of a housing of a base assembly according to an embodiment of the present invention;

FIG. 18 is a side elevation view of a housing of a base assembly according to an embodiment of the present invention;

FIG. 19 is a perspective view of a cam of a base assembly according to an embodiment of the present invention;

FIG. 20 is a top plan view of a cam of a base assembly according to an embodiment of the present invention;

FIG. 21 is a side elevation view of a base assembly according to an embodiment of the present invention;

FIG. 22 is a bottom plan view of a base assembly according to an embodiment of the present invention;

FIG. 23 is a perspective view of a keeper attached to a window sash according to an embodiment of the present invention;

FIG. 24 is a perspective view of a keeper according to an embodiment of the present invention;

FIG. 25 is a front elevation view of a keeper according to an embodiment of the present invention;

FIG. 26 is a rear elevation view of a keeper according to an embodiment of the present invention;

FIG. 27 is a side elevation view of a keeper according to an embodiment of the present invention; and

FIG. 28 is a bottom plan view of a keeper according to an embodiment of the present invention.

While the present invention is amendable to various modifications and alternative forms, specifics thereof have been shown by way of example in the drawings and will be described in detail. It should be understood, however, that the intention is not to limit the present invention to the particular embodiments described. On the contrary, the intention is to cover all modifications, equivalents, and alternatives falling within the spirit and scope of the present invention.

### DETAILED DESCRIPTION OF THE PREFERRED EMBODIMENTS

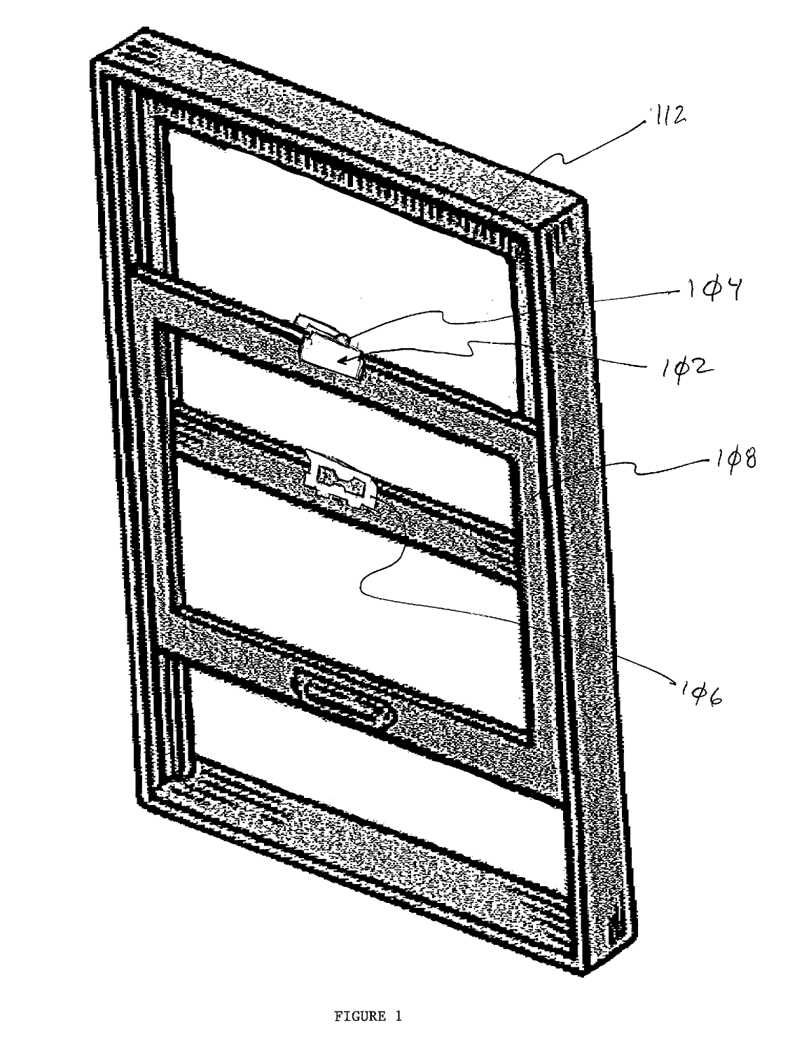

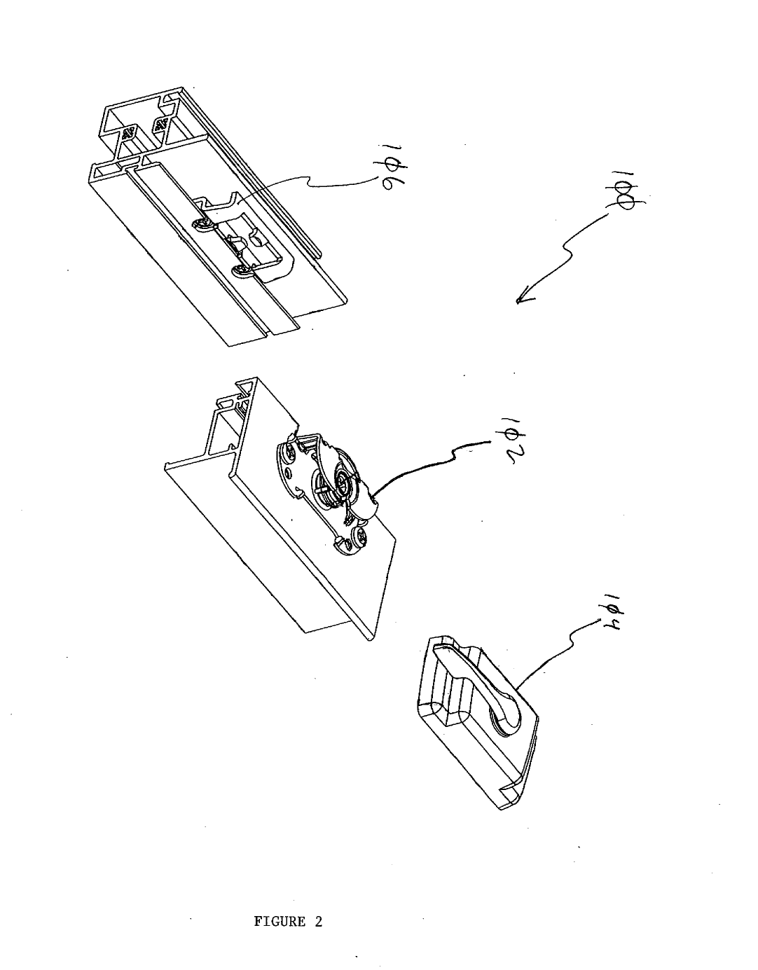

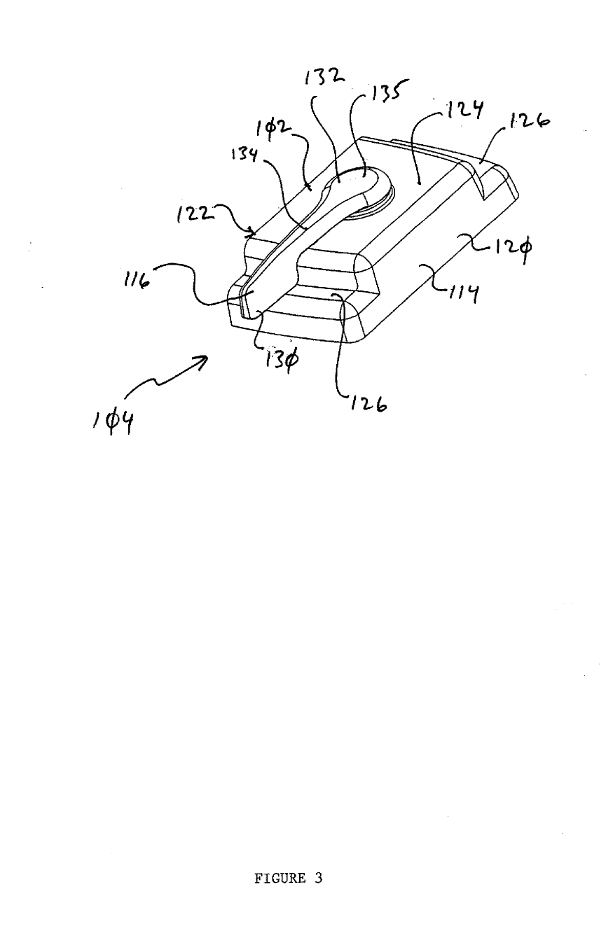

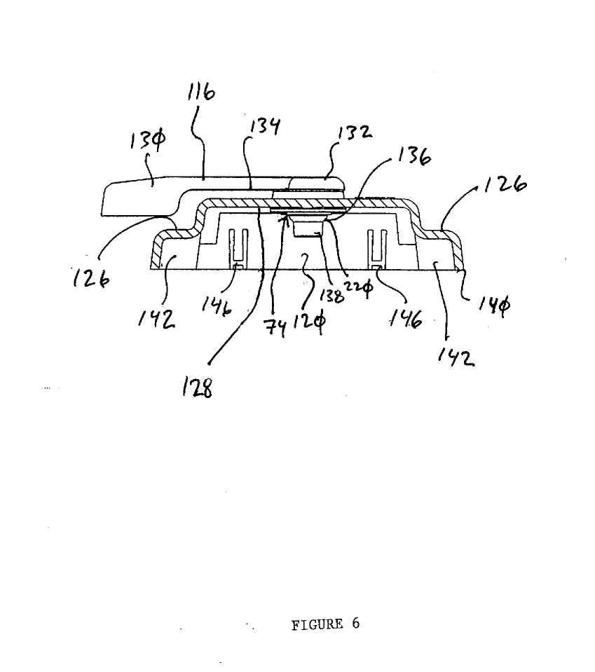

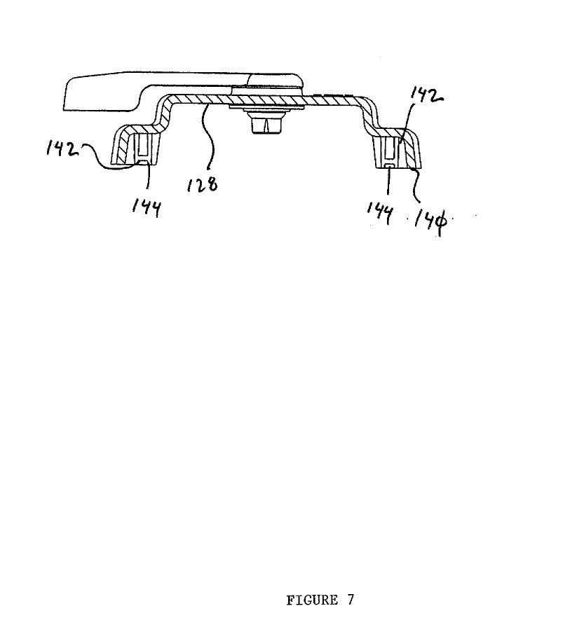

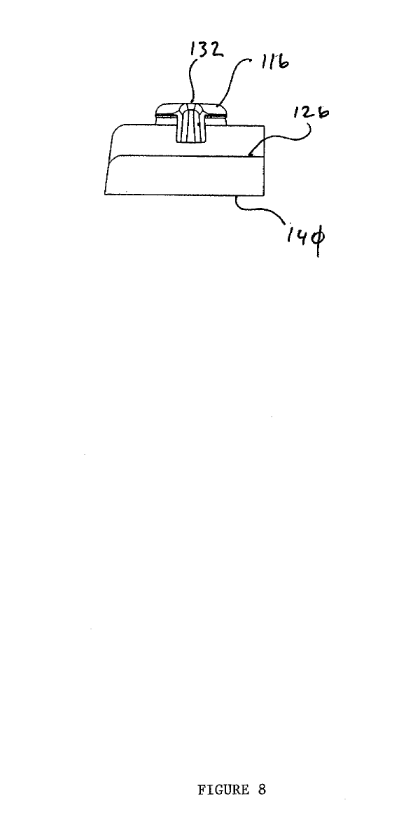

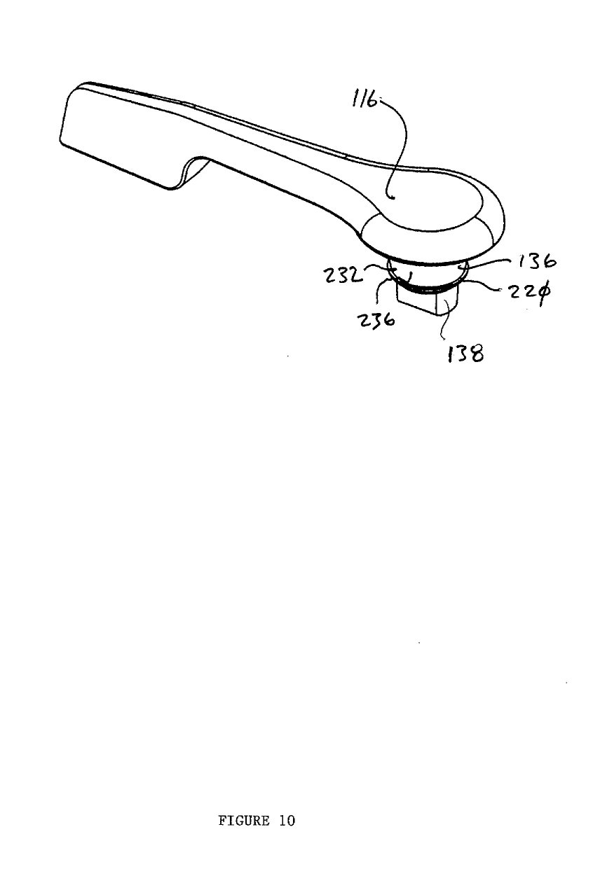

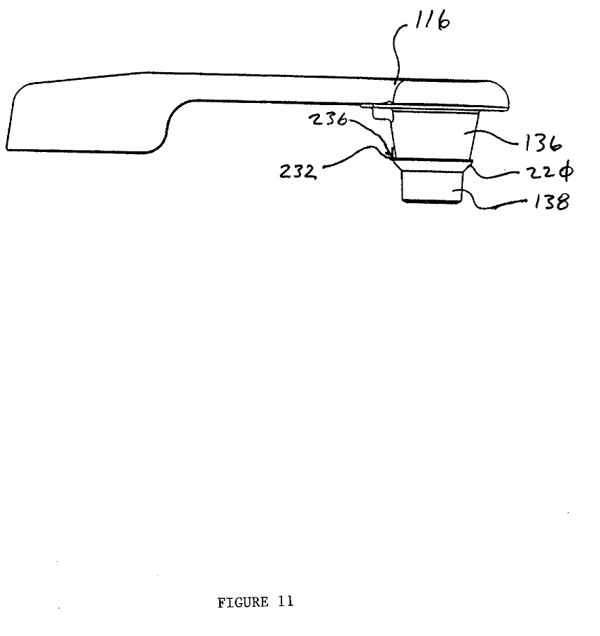

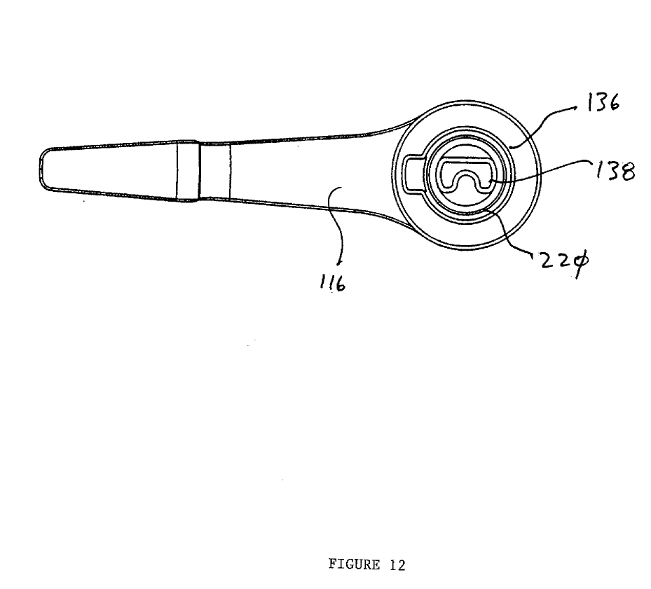

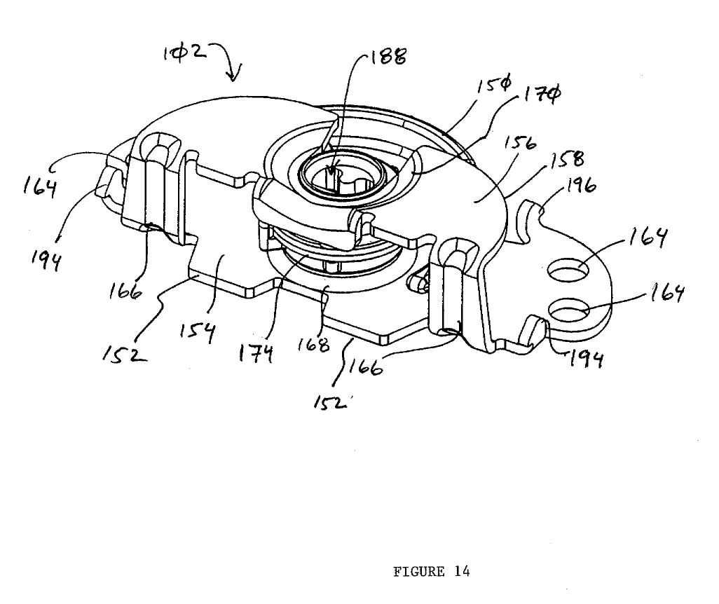

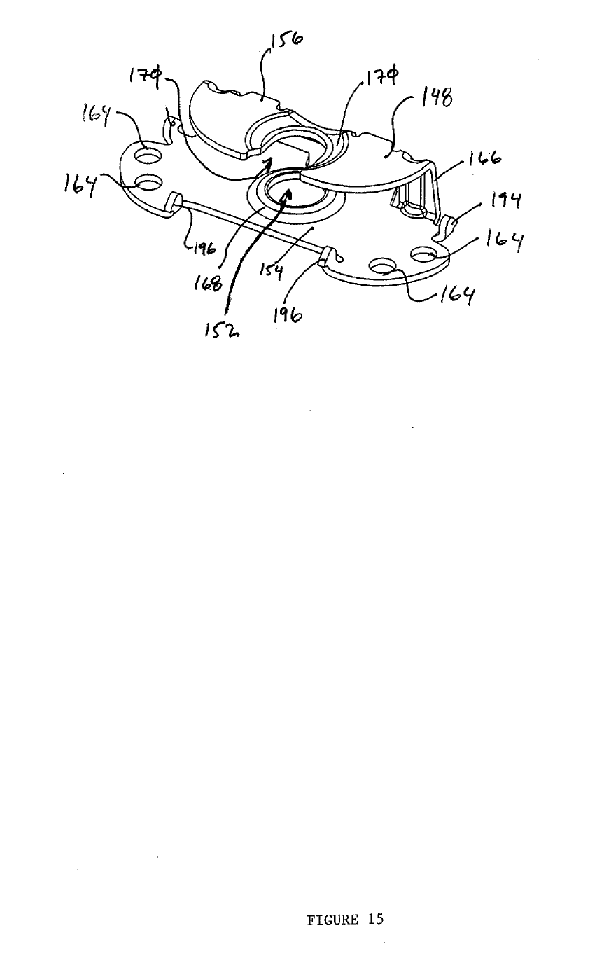

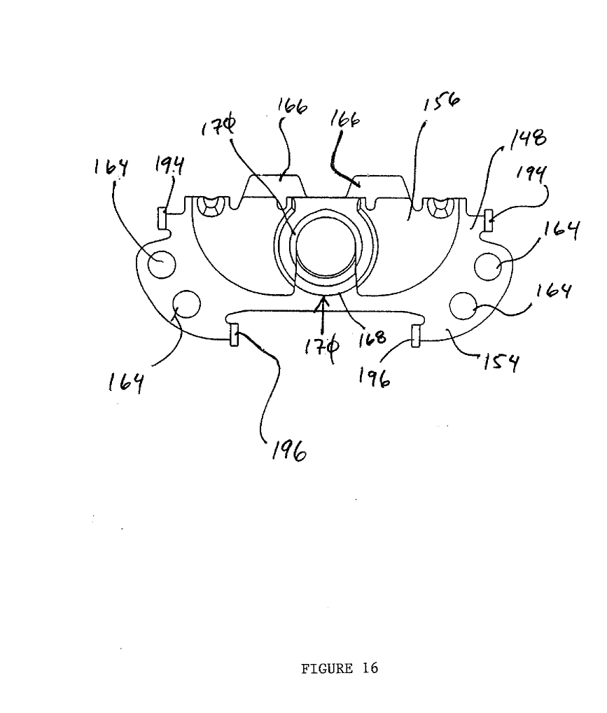

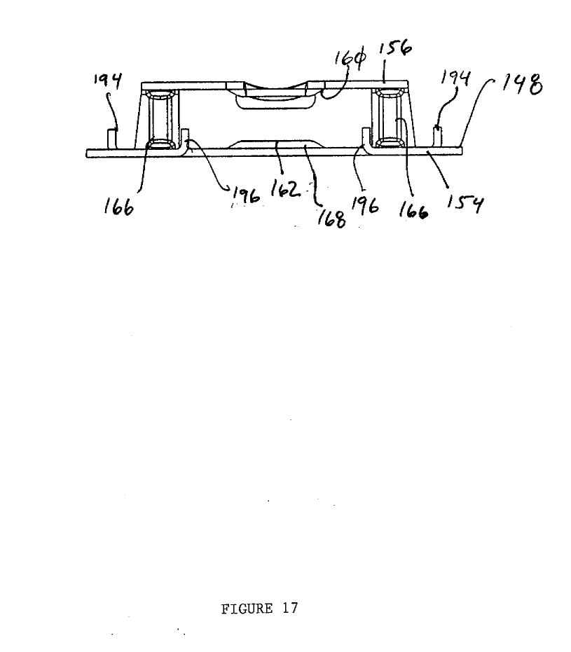

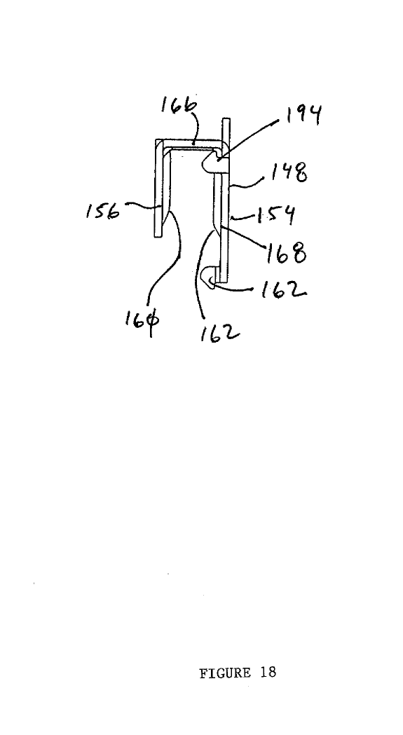

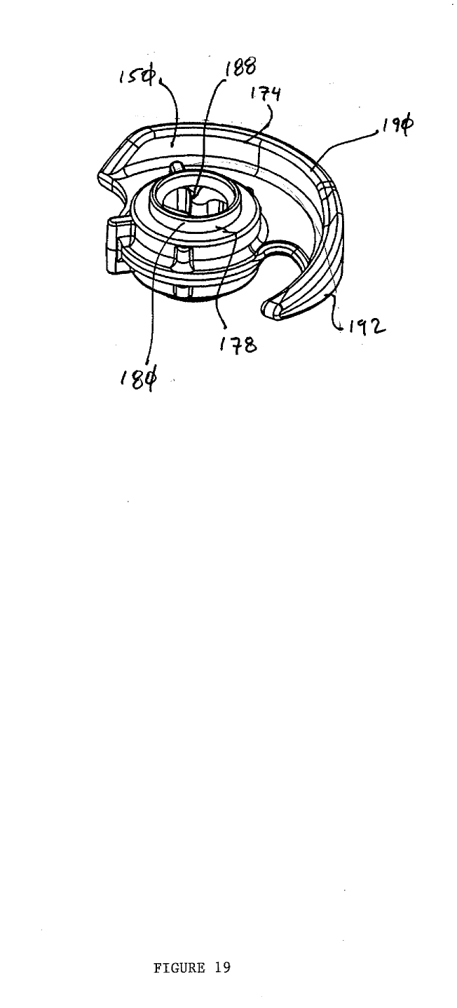

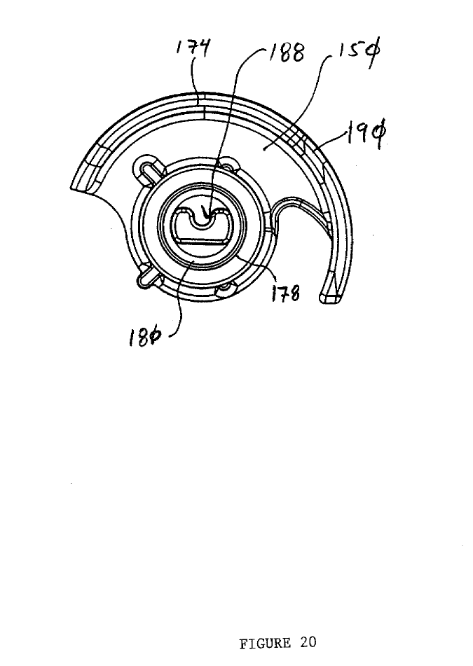

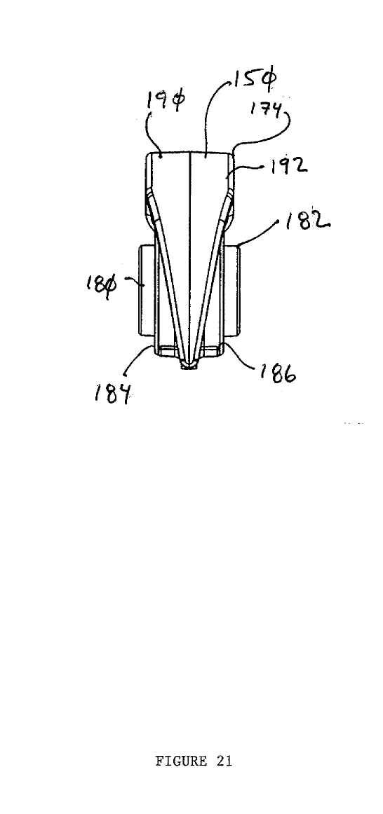

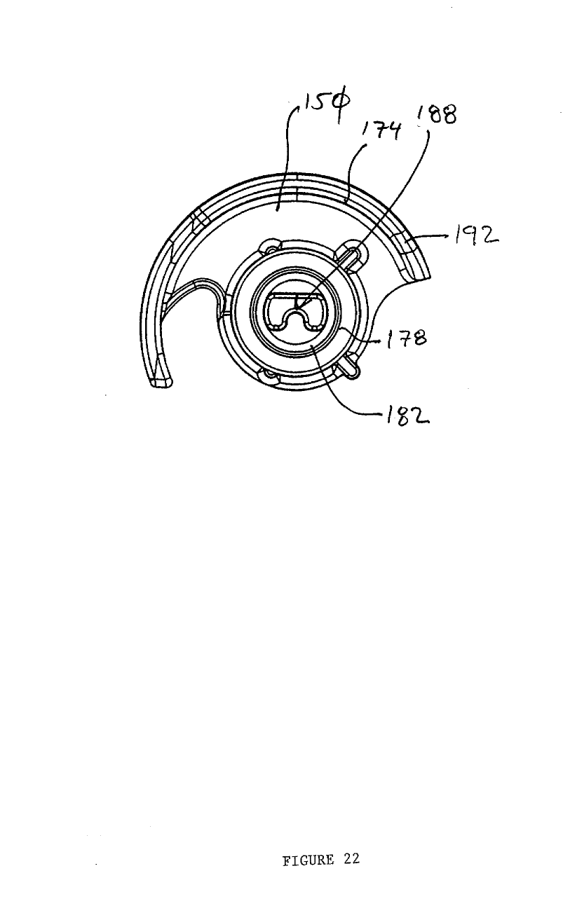

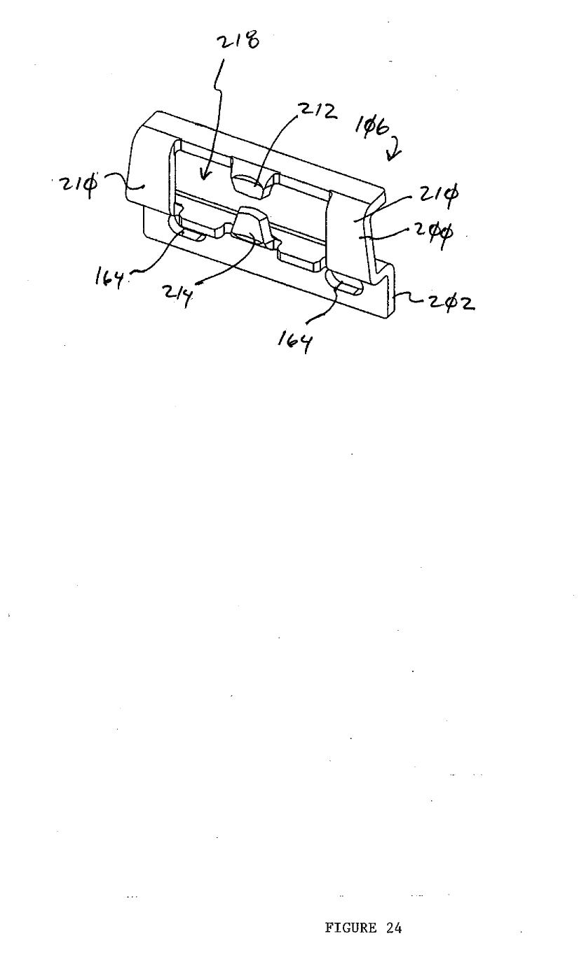

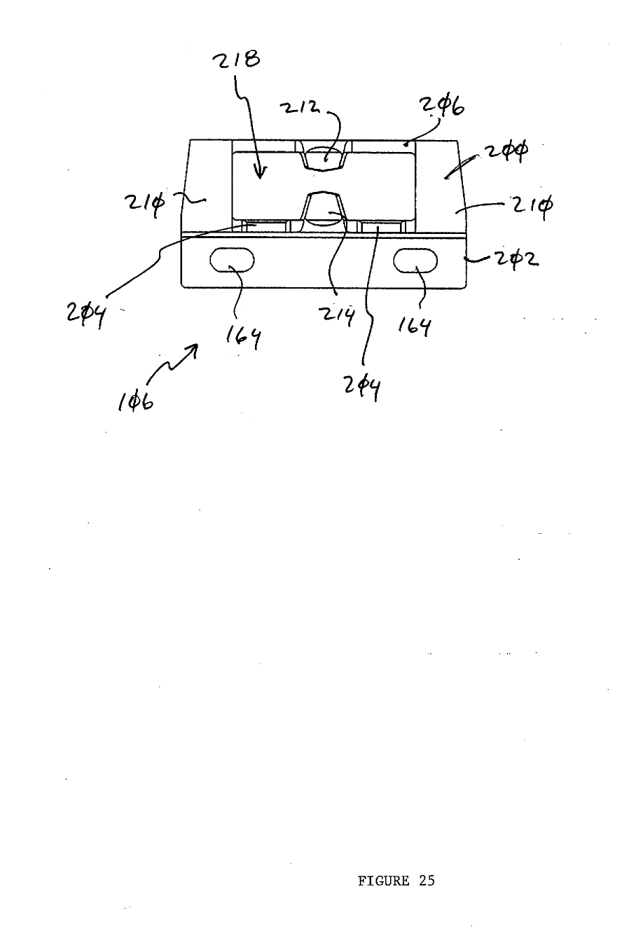

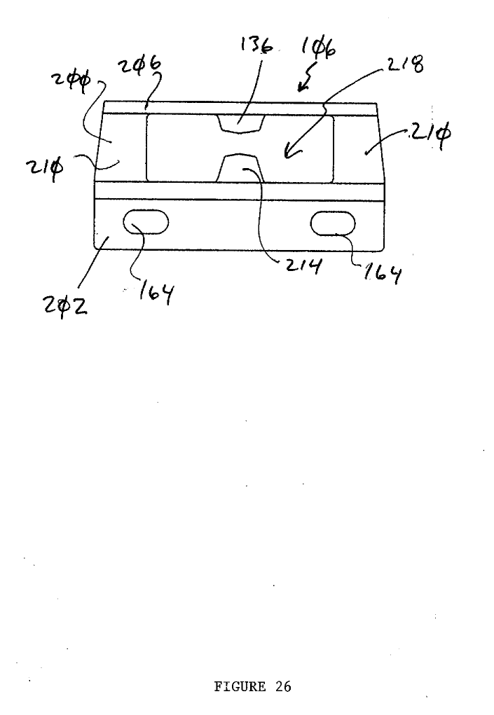

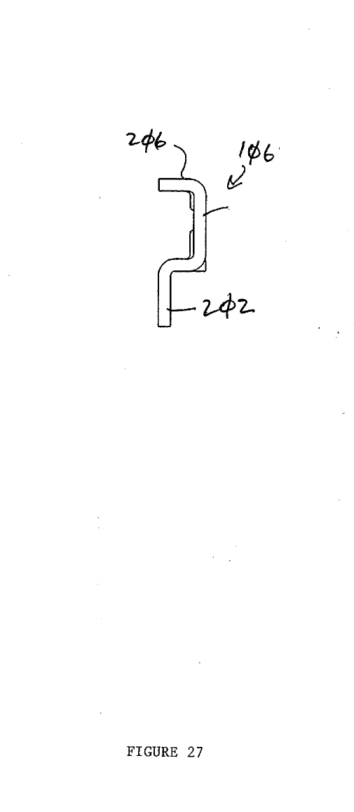

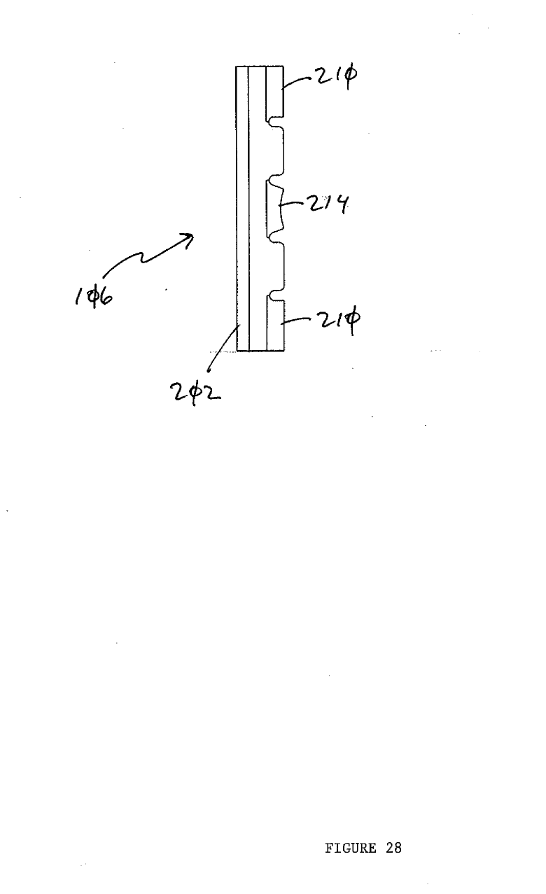

Referring to FIGS. 1-2, a locking system is depicted generally with reference numeral 100. Although the various components of locking system 100 depicted in FIGS. 1-28 are adapted for use in a check rail locking system, one skilled in the art will readily recognize that the components locking system 100 may include other configurations for use in other types of locking systems 100. As such, the embodiments of the present invention depicted in FIGS. 1-28 are merely illustrative of one such locking system 100. Other locking systems 100 may also incorporate alternative embodiments the present invention.

Locking system 100 generally includes base assembly 102, cover assembly 104, and keeper 106, as depicted in FIG. 2. Base assembly 102 is mounted onto window sash 108. Window sash 108 may be) for example, a lower window sash of a double hung window. Cover assembly 104 is attached to base assembly 102. In an example embodiment, cover assembly 104 snaps onto base assembly 102. In an alternative embodiment, base assembly 102 and cover assembly 104 are installed onto window sash 108 as a single component. Keeper 106 is attached to bottom rail 110 of window sash 112. Window sash 112 may be, for example, an upper window sash of a double hung window. Base assembly 102 can cooperate with keeper 106 such that base assembly 106 and keep 106 may be engaged so as to lock window sashes 108, 112 in a shut position.

Referring to FIGS. 2-12, cover assembly 104 includes cover body 114 and handle 116. Cover body 114 generally forms the housing structure of cover assembly 104. Cover body 20 includes a solid distal face 120, opposing keeper face 122 that is open, handle face 124, a pair of optional finger shoulders 126, and base-engaging face 128. Handle 116 is disposed on handle face 124. Handle 116 includes thumb lever 130, cam mount 132, handle extension 134, shaft 135, and integral shaft 136. Thumb lever 130 and cam mount 132 are generally connected by handle extension 134. Thumb lever 130 is spaced outboard of finger shoulders 126 to eliminate contact between finger shoulders 126 and thumb lever 130 during rotation. Integral shaft 136 is disposed directly below cam mount 132. The lower end of integral shaft 136 includes orientation lug 138.

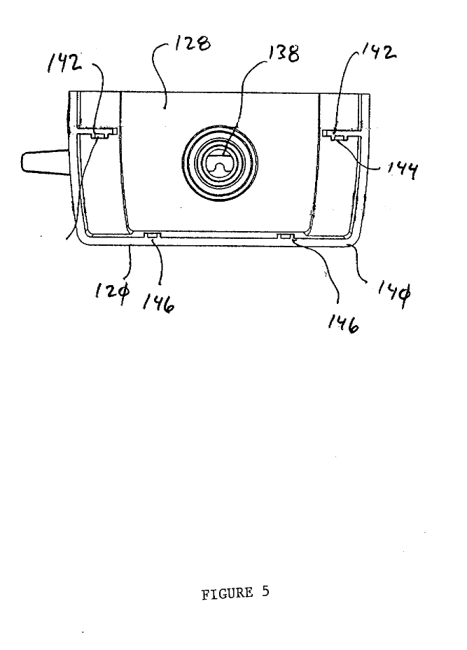

Base-engaging face 128 is located on the underside of cover assembly 104, as depicted in FIGS. 5-7. Base-engaging face 128 is defined by base perimeter 140. Although base perimeter 140 may have any number of shapes, base perimeter 140 generally has a horseshoe shape. Optional finger shoulders 126 form a step within base-engaging face 128.

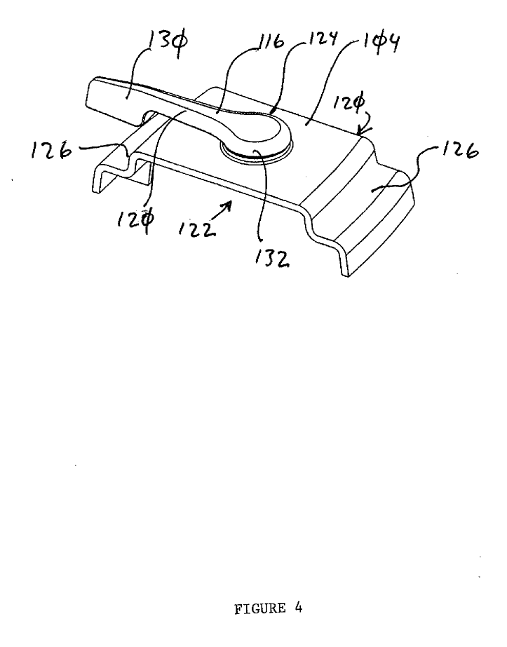

Referring to FIGS. 4-7, each finger shoulder 126 defines shoulder support 138. Shoulder support 138 extends from the interior face of finger shoulder 126 to the plane defined by base perimeter 136. Shoulder supports 138 include upper tab locks 144. Distal faces 120 include lower tab locks 146. Upper tab locks 144 and lower tab locks 146 generally extend outward from respective support walls for engaging locking devices on base assembly 102. Although upper tab locks 144 and lower tab locks 146 may be any shape, upper and lower tab locks 144, 146 are generally U-shaped tabs.

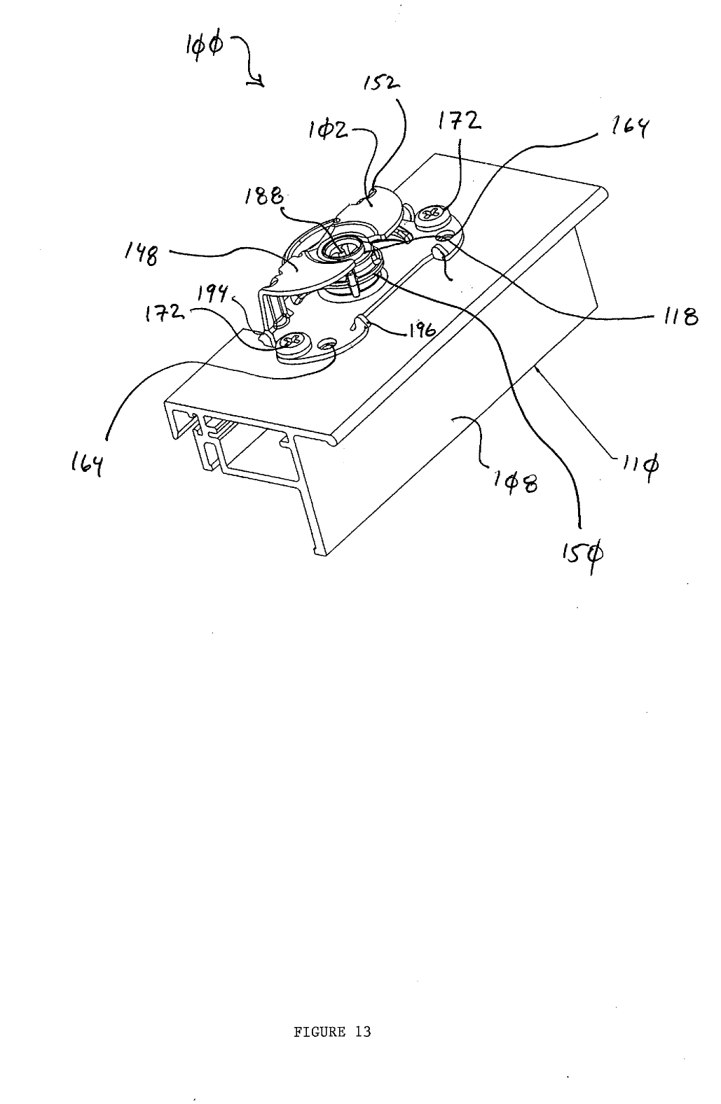

Referring to FIGS. 13-22, base assembly 102 includes housing 148, cam 150, and FER barriers 152. Base assembly 102 also defines aperture 153. FER barriers 152 are disposed on opposite sides of cam 150 and extend distally from base assembly 102. Housing 148 includes base support 154 and upper support 156. Housing 148 also defines open side 158, undersurface 160, and top surface 162, and mounting apertures 164. Housing 148 generally forms a cradle for cam 150. Specifically, base support 154 and upper support 156 are connected by barrier walls 166. Base support 154 has cam mount 168. Upper support 156 includes conical guide 170. Conical guide 170 is generally angled toward base support 154 to direct orientation lug 138 of cover assembly 104 towards cam 118. Upper support 156 and cam mount 168 define notch 172. Notch 172 is adapted to be slidingly engaged by cam 150. Mounting apertures 164 are generally adapted to receive fastening members 174, such as, for example screws, for mounting base assembly 102 to a window rail of window sash 108.

Cam 150 includes spiral cam flange 176, spiral annular member 178, upper collar 180, lower collar 182, and shoulders 184, 186. Cam 118 also defines opening 188 and is generally adapted to be operably engaged by handle 116. Opening 188 is a coded opening adapted to receive orientation lug 138 in an example embodiment. Spiral cam flange 176 has upper rib 190. Spiral cam flange 176 may also have lower rib 192. Upper and lower ribs 190, 192 are located on the major radius of spiral cam flange 176, defining a generally T-shaped cross section. Spiral annular member 178 is located at the center of cam 150 and surrounds orientation lug 132. Generally, when locking system 100 is in an unlocked position, spiral cam flange 174 is situated with the interior spaces of base assembly 102 and can be moved to an engaged position for contact with the keeper 106.

Cam 150 is snapped into housing 148 by advancing cam 150 between base support 154 and upper support 156 with upper collar 180 registered with notch 170. As cam 150 is advanced, shoulder 184 engages undersurface 160 and shoulder 186 engages top surface 162, deflecting base support 154 and upper support 156 away from each other. Once lower collar 182 registers with aperture 152, the bias exerted by the deflection of base support 154 and upper support 156 urges lower collar 182 into aperture 152 such that shoulder 186 rides on cam mount 168. Upper collar 180 extends upward though notch 170 with shoulder 184 riding on undersurface 160. Cam 150 is rotatable in this position and the bias of upper support 156 retains lower collar 182 in place in aperture 152. It will be appreciated that so long as the distance between shoulders 184, 186 is maintained and the diameter of collars 180, 182 is maintained, nearly all other characteristics of cam 150, such as the diameter and configuration of spiral cam flange 176, may be altered so as to create a multiplicity of different yet interchangeable cams to be used with base housing 148. In this way, the locking system 100 is quickly and easily adaptable to a variety of keeper and sash configurations, merely by snapping a desired one of the interchangeable cam 150.

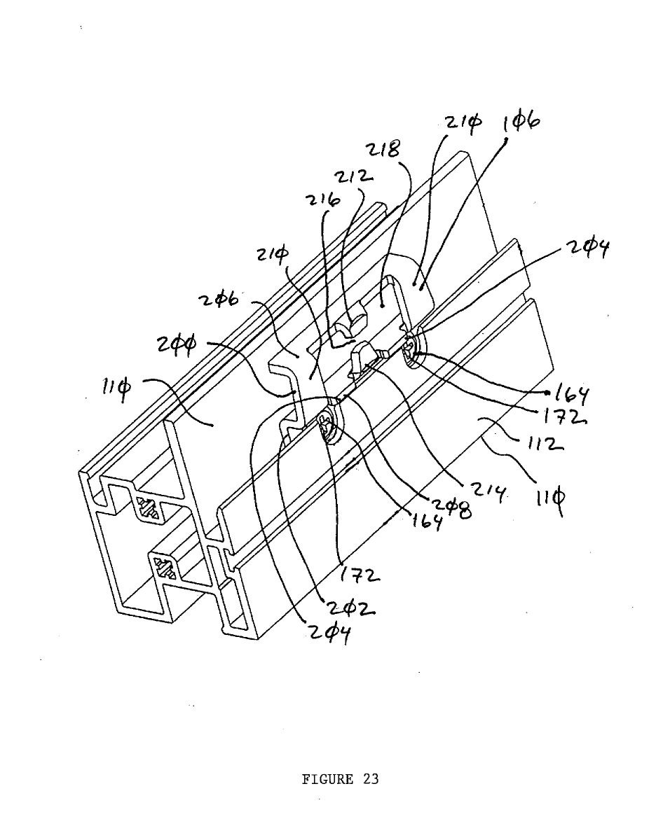

Referring to FIGS. 23-28, keeper 106 includes keeper body 200 and mounting flange 202. Keeper 106 also defines mounting apertures 174. Mounting apertures 164 are generally adapted to receive fastening members 174, such as, for example screws, for mounting keeper 106 to a window rail of window sash 112. Keeper body 200 has FER barrier tabs 204, upper margin 206, and lower margin 208, and legs 210, upper keeper tab 212, and lower keeper tab 214. Keeper 106 also defines cam gap 216 and locking aperture 218. Although keeper body 200 can be any number of shapes, keeper body 200 generally has a horseshoe shape disposed such that the opening of the “horseshoe” is oriented toward window sash 112. Mounting flange 202 generally extends distally from keep body 200 into a slot defined by the interlocking rails 110 of window sashes 108, 112. FER barrier tabs 204 generally project from lower margin 208 and extend distally from window sash 112. FER barrier tabs 204 thereby substantially block contact with cam 150 of base assembly 102. Upper keeper tab 212, lower keeper tab, 214, and cam gap 216 are all centered upon the same vertical plane that aligns with the center of cam 150. Upper keeper tab 212 and lower keeper tab 214 are separated by cam gap 216 and extend into locking aperture 218. Locking aperture 218 is defined by upper margin 206, lower margin 208, and FER barrier tabs 204. Although locking aperture 218 can be any shape, locking aperture 218 generally defines an H-shaped gap that allows cam 150 to rotatingly engage upper keeper tab 212 and lower keeper tab 214. Legs 210 extend distally from window sash 115. The thickness of cam gap 216 is generally slightly more than the thickness of the base of the T-shaped cross section of upper and lower ribs 190, 192 of spiral cam flange 174.

Base assembly 102, cover assembly 104, and keeper 106 can be made from any number of materials. In an example embodiment, base assembly 102 is constructed of non-zinc material, cover assembly 104 is constructed from a non-metallic material, and keeper 106 is made with typical zinc die-cast materials or sheet-steel stamping with zinc plating. Housing 148 and cam 150 can be made of different materials, such as, for example, if housing 148 is made of steel and cam 150 is made of a non-metallic material. Housing 148 and cam 150 can also be made of the same type of material. Keeper 106 can also be made from stamped sheet stainless steel.

Base assembly 102 is generally adapted to interchangeably receive cover assemblies 104. In an example embodiment, cover assemblies 104 are snap-fit onto base assemblies 102. Specifically, base assembly 102 can further include opposing upper tab 194 and lower tab 196 for a snap-on fit of the cover assembly 104. Upper tabs 194 are positioned adjacent to cam mount 168 of base support 154. Each upper tab 194 includes a hooked distal end for engagement with upper tab lock 144 of cover assembly 104. Lower tabs 196 are located adjacent to barrier walls 166. Each lower tab 196 includes a hooked distal end for engagement with lower tab lock 146. The distal ends of upper tabs 194 and lower tabs 196 are rounded to facilitate proper contact with cover assembly 104.

During operation, cover assembly 104 is placed over base assembly 102 so that orientation lug 138 fits within annular member 178 of cam 150. By applying a downward force on the cover assembly 104, upper tab locks 144 and lower tab locks 146 will catch on upper tab 194 and lower tab 196, respectively. Handle 116 is operably connected to spiral cam flange 174 through the handle shaft 135, integral shaft 136, and orientation lug 138 so that rotation of the handle 116 engages the cam 150 of the base assembly 102 so as to rotate and extend the spiral cam flange 174 towards the keeper 106.

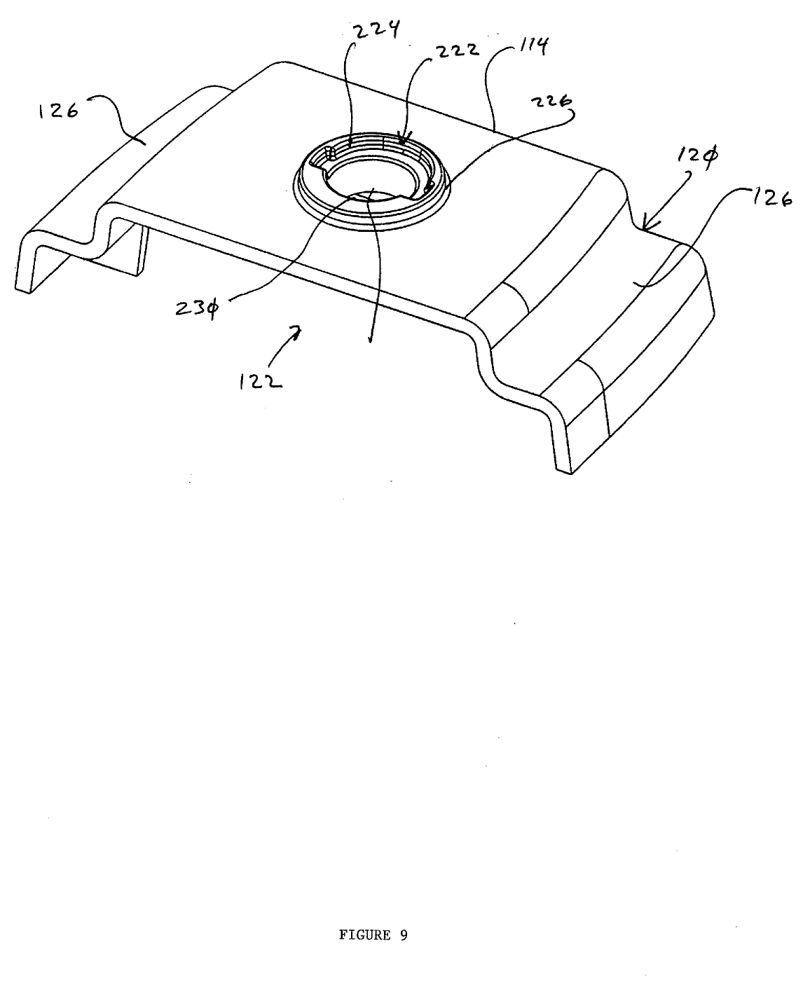

Cover assembly 104 is generally adapted to be snap-fit onto base assembly 102. To facilitate such snap-fit, integral shaft 136 of handle 116 includes beveled collar 220 positioned just above orientation lug 138 in an example embodiment, as depicted in FIGS. 9-12. Lock cover body 114 defines handle aperture 222 surrounded by raised boss 224 at upper end 226 and locking structure 228 at lower end 230. Locking structure 228 may be a flexible collar or snap ring structure surrounding an opening with a slightly lesser diameter than upper lip 232 of beveled collar 220. Locking surface 228 defines face 234 and upper surface 236.

During assembly, integral shaft of handle 116 is advanced downwardly though handle aperture 222 until beveled collar 220 encounters locking structure 228. As handle 116 is advanced further downward, the bevel of beveled collar 220 deflects locking structure 228, gradually increasing the diameter of the opening defined thereby. Once upper lip 232 passes locking structure 228, locking structure 227 snaps back to its original opening diameter. The face 234 of locking structure 228 confronts upper surface 236 of beveled collar 220 to prevent withdrawal of handle 116 from handle aperture 222.

With the disclosed snap-fit cover assembly 104, a multiplicity of different yet interchangeable configurations of lock cover bodies 114 and handles 116 may be produced that are adapted to attach to base assembly. Locking system 10 thereby provides a variety of sash configurations and aesthetic schemes that can quickly and easily be adaptable by snapping on a selected cover assembly 104. Locking system 100 can thereby also improve installation efficiency cover assembly 104 can be attached so as to cover base assembly after events which might mar base assembly 102, such as painting or staining, have occurred. In addition, locking system 100 can thereby provide additional FER protection. Specifically, application of excessive opposing force against locking system 100 urges cover assembly 104 “pop” off base assembly 102, thereby causing handle 116 to disengage from cam 150 and making it more difficult to access and rotate cam 150 to gain entry.

In use, locking assembly 100 provides forced-entry resistance when the sash or sashes of a window unit is or are closed. When closing a double-hung window, for example, the meeting rash of window sash 108 is aligned with the meeting rail of window sash 112. With window sashes 108, 112 properly positioned in relation to each other, handle 116 located on cover assembly 104 can be rotated so that cam 150 engages keeper 106. In an example cover assembly 104 forms a shroud over base assembly 102 and keeper 106 so as to substantially cover base assembly 102 and keeper 106. When handle 116 is manipulated so that cam 150 is rotated into the locked position, locking system 110 can provide increased FER protection.

The embodiments above are intended to be illustrative and not limiting. Additional embodiments are encompassed within the scope of the claims. Although the present invention has been described with reference to particular embodiments, those skilled in the art will recognize that changes may be made in form and detail without departing from the spirit and scope of the invention. For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed:

1. A window system comprising:
a window frame;
a first window sash and a second window sash, at least one of the first window sash or the second window sash selectively shiftable within the window frame; and
a locking system, the locking system comprising:
a base assembly on the first window sash, the base assembly including a housing and a cam, the housing having an upper plate and a lower plate, the upper and lower plates defining substantially parallel spaced-apart planes, the upper and lower plates having cooperating structure for rotatably receiving and retaining the cam and being resiliently coupled so as to be deformably shiftable relative to each other to enable selective removal and replacement of the cam;
a cover assembly over the base assembly, the cover assembly including a shroud and a handle, the handle being operably coupled to the cam; and
a keeper on the second window sash and adapted to receive the cam.

2. The window system of claim 1, wherein the cam is selectively interchangeable with a second cam.

3. The window system of claim 2, wherein the cam defines a first flange configuration and presents a first diameter and the second cam defines a second flange configuration and presents a second diameter, the first and second flange configurations and the first and second diameters being different.

4. The window system of claim 1, wherein the cam includes upper and lower projections, the upper plate defines an upper cam-receiving aperture adapted to receive the upper projection of the cam, and the lower plate defines a lower cam-receiving aperture adapted to receive the lower cam projection.

5. The window system of claim 4, wherein the cam is rotatable within the upper and lower cam-receiving apertures.

6. The window system of claim 1, wherein the housing is adapted to retain the cam without a fastening member.

7. A window system comprising:
a window frame;
a first window sash and a second window sash, at least one of the first and second window sashes being selectively shiftable within the window frame; and
a locking system, the locking system comprising:
a base assembly on the first window sash, the base assembly including a cam receiver and a cam selectively rotatable within the cam receiver, the cam receiver being resiliently deformable to enable selective removal and replacement of the cam from the base assembly;
a cover assembly over the base assembly, the cover assembly including a shroud and a handle, the handle being operably coupled to the cam; and
a keeper on the second window sash, the keeper adapted to receive the cam.

8. The window system of claim 1, wherein the cam is interchangeable with a second cam.

9. The window system of claim 8, wherein the cam defines a first flange configuration and presents a first diameter and the second cam defines a second flange configuration and presents a second diameter, the first and second flange configuration and the first and second diameters being different.

10. The window system of claim 7, wherein the cam receiver presents spaced-apart first and second cam retainers.

11. The window system of claim 10, wherein the cam includes upper and lower projections, the first cam retainer defines an upper cam-receiving aperture adapted to receive the upper projection of the cam, and the second cam retainer defines a lower cam-receiving aperture adapted to receive the lower cam projection.

12. The window system of claim 11, wherein the cam is rotatable within the upper and lower cam-receiving apertures.

13. The window system of claim 7, wherein the cam receiver is adapted to retain the cam without a fastening member.

14. A window system comprising:
a window frame;
a first window sash and a second window sash, the first and second window sashes being shiftable within the window frame; and
a locking system comprising:
a base assembly on the first window sash, the base assembly including a cam receiver and a cam rotatably received by the cam receiver, the cam defining a shaft-receiving opening;
a cover assembly over the base assembly, the cover assembly including a shroud and a handle unit, the shroud being resiliently deformable to receive and conformingly retain the base assembly and the handle unit including a lever with a shaft shaped to conformingly fit within the shaft-receiving opening of the cam; and
a keeper on the second window sash, the keeper adapted to receive the cam.

15. The window system of claim 14, wherein the shroud defines an aperture adapted to receive the shaft of the handle unit.

16. The window system of claim 15, wherein the shroud is resiliently deformable to receive and retain the handle unit.

17. The window system of claim 14, wherein rotation of the handle unit produces a corresponding rotation of the cam.

18. The window system of claim 14, wherein the handle is self-disengagable from the cam if a force is applied to the shroud.

19. A window system comprising:
a window frame;
a first window sash and a second window sash, at least one of the first and second window sashes being selectively shiftable within the window frame; and
a locking system comprising:
a base assembly on the first window sash, the base assembly including a cam receiver and a cam rotatably received in the cam receiver, the cam presenting an axis of rotation, the cam receiver defining a cam exit opening transverse to the axis of rotation of the cam, wherein the cam is selectively rotatable between a first position wherein a portion of the cam projects through the cam exit opening and a second position wherein the cam is clear of the cam exit opening, the base assembly further including a first barrier structure projecting outward from at least one side of the cam exit opening; and
a keeper on the second window sash, the keeper defining a cam-entry opening for receiving the cam and including a second barrier structure projecting outwardly relative to the cam-entry opening, the keeper further including first and second projections, the first projection being vertically registered with the second projection, wherein when the first and second sashes are positioned such that the cam exit opening of the base structure is registered with the cam entry opening of the keeper and the cam is positioned in the first position, the cam is engaged with the first and second projections and the first barrier structure and the second barrier structure are cooperatingly positioned to inhibit access to the cam from outside the window.

20. The window system of claim 19, wherein the first barrier structure and the second barrier structure overlap when the window is in a closed position.

21. The window system of claim 19, wherein the first projection substantially confronts and is slightly offset from the second projection.

22. The window system of claim 19, wherein the cam further defines a flange comprising a pair of opposing generally vertical walls, and wherein when the first and second sashes are positioned such that the cam exit opening of the base structure is registered with the cam entry opening of the keeper and the cam is positioned in the first position, a portion of one of the vertical walls is positioned behind the first projection and a portion of the other of the vertical walls is positioned behind the second projection.

23. The window system of claim 19, wherein the first and second projections are substantially transverse to the axis of rotation of the cam.
